(19) United States
(12) Patent Application Publication
(10) Pub. No.: US 2020/0043330 A1
(43) Pub. Date: Feb. 6, 2020

(54) Traffic Signal Pan-Greenwave Control Method

(71) Applicant: Weiping Meng, Flushing, NY (US)

(72) Inventor: Weiping Meng, Flushing, NY (US)

(21) Appl. No.: 16/586,881

(22) PCT Filed: Apr. 3, 2018
(86) PCT No.: PCT/CN2018/000126

§ 371 Date: Sep. 27, 2019

(30) Foreign Application Priority Data
Apr. 7, 2017 (CN) 201710224791.X

(51) Int. Cl. G08G 1/082; G08G 1/08

(52) U.S. Cl. CPC G08G 1/082; G08G 1/08

(57) ABSTRACT

The invention relates to a traffic signal mode field, discloses a formula called pan-greenwave no redundant time-offsets that make signal smoothly change among positive time-offset, negative, 0 of 3 states with the change of traffic load from sparse to density, and its implementing method for broad-band differential (BBD) greenwave, and 3 no-redundance time-offset states, Lead, Balance, Relief, multiple-state-greenwave pan-greenwave control method, including Start/Vanish, Fluctuation, Drift, State change, and create Solitary wave as Seamless response to sudden load, main steps include: obtain traffic data; use BBD greenwave for sparse traffic; signals switch to Lead state as more vehicles come intensive; signals enter to Balance state as further more vehicles come to; as more and more vehicles come, signals change to Relief state; while, decreasing vehicles' coming will causes signals reversely change state by state, Relief->Balance->Lead->BBD greenwave. The advantages is: avoid redundant stops/start per period of each vehicle in each lane of each road-segment, about 30 seconds equivalent to idle fuel-consumption, averagely decrease 30 vehicles' about 15 minutes idle fuel consumption in each road-segment; Unifying 4-state greenwave in a road with solitary wave technology for early resolving congestion core and postpone large scale congestion provides systemically successive traffic signal control schemes of solution, improve the capability of traffic signals response with traffic change.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to the field of traffic signal mode control, particularly to traffic signal control methods that initiate a greenwave and adjust it following traffic.

Currently the basic traffic signal modes are: RATIO and GREENWAVE. Artery-type greenwaves enables “vehicles follows a green wave going to the unlimited end of this wave”, which indeed solved the RATIO mode's problem that a green light permits vehicles to move at most such a distance that is set-drive-speed multiplied by the time of the green light; however, it still wastes some green light time. A new ably designed method has disclosed, a time-differential ratio technology that dynamically adjusts ratio-set of an intersection based on traffic information obtained from specially equipped sensors, thus, realize broad spectrum real time differential greenwave response with small traffic load, basically solves the waste of green lights. Common greenwave technology is often used under above medium traffic load, their preset time-offsets of every road-segment often lose anticipated effectiveness due to the increasing vehicles in front of intersections and leads redundant stops and vehicle-gather, meanwhile these gather are discovered frequently to be early incentive of core-style-congestion. It should be set down for high efficiency greenwave that can properly adjust greenwave time-offsets with changing traffic queue, linking up and down mode.

### BRIEF SUMMARY OF THE INVENTION

It is an object of the present invention to solve above problem of greenwave time-offset's response with vehicles' queue's change.

The present invention provides a solution to achieve the above object, extending the previous invented broad spectrum differential greenwave, the method of minimum safety response time, i.e. “differential switch time” or differential time or phase-change quantum time, based on time-offset greenwave\textcircled{1} that includes Synchronization, Lead, Jam-Relief of three mode, and a real time moding method, designs synthetic architecture and operation method with the response of traffic queue in order to eliminate the redundancy stop and its aggregation caused by the change of the queues at intersections; in virtue of its optimal organic unity of the control methods of differential greenwaves, Lead greenwaves, balance and Jam-Relief greenwaves which are good at dealing with corresponding respectively to one of four increment traffic load intervals and are connected together in no redundant stop/start optimal way, it is named as pan-greenwaves. The features of the present invention are as follow:

A method for traffic pan-greenwave mode in road traffic signal network includes steps\textcircled{2}:

S1: Initialize signal system as mode RATIO with obtaining the length d and traffic-time of road-segments of a roadnet: set-drive-time tv, tv=d/v0, v0—set-drive-speed following a green wave in set direction of a road-segment;

S2 obtain real time traffic information: the tail q of vehicles' queue in every road-segment, the head q0 info of this queue, road-queue time-offset trq, phase-change quantum time [symbol] t (i.e., differential time);

S3 calculate and configure pan-greenwave time-offset tgw according to a mode-instruction or vehicles' queue's length at an intersection: 1) greenwave-initiate/vanish-drift: determine the initiate, drift, vanish and their time-offsets of a greenwave's direction and channel's two ends: start-point, front-point, 1.1) according to an empirical-data' instruction, or, 1.2) self-adaption according to real time traffic flow characteristics, 1.2.1) greenwave-initiate: (1) choose the channels of potential 2-way coordinates or more road-segments with waiting vehicle queue or longer queue as greenwave channel and flow direction, configure/reconfigure/vanish a greenwave, (2) its start-point is the first intersection along a channel direction, i.e., the most upstream intersection of non-differential state or non small load (i.e., the time-distance between moving vehicles is bigger than the quantum phase-change time), its front-point is the last intersection along a channel direction, i.e., the most downstream intersection of non-differential state or non small load, (3) calculate time-offset tgw and configure its interim-period of every intersection of a greenwave channel, the time-offset is the sum of the time difference from the start-intersection to its downstream intersection, where the time-difference is that the time-distance from a moving vehicle to an intersection minus the vehicle queue-start-time tq in front of the intersection, 1.2.2) greenwave-drift: calculate and configure wave-wave interim-period from new start point and front point and their caused new intersection period-remainder and their new time-offsets that equals to the new start/front points' caused time-offsets plus its current time-offset's complement, 1.2.3) greenwave-vanish: calculate and configure wave-vanish interim-period that is new start point and front point's superposition, i.e., the number of road-segments included within the new channel 0—wave vanish, 2) greenwave-fluctuation: adjust the time-offset of every intersection according to the change [symbol] q of vehicles' queue q or an instruction after wave-initiate: take the time trq's change [symbol] trq caused by the change [symbol] q into the time-offsets tgw, trq of the local intersection and its downstream intersections, which is inverse ratio change, increased queue leads [symbol] trq<0 and trq decrement, decreased queue leads [symbol] trq>0 and trq increment; 3) greenwave state-change: change state among Lead, Balance, Relief according to the change [symbol] q of vehicles' queue q or an instruction after wave-initiate: with queue's increment, the time-offset trq in Lead state decreases to 0 and becomes Balance state, with queue's increment further, the trq<0 and switches to Relief state, and conversely, with decrement q, the time-offset trq<0 in Relief state increases to 0 and becomes Balance state, with further decrement q, the trq>0 and switches to Lead state; 4) solitary wave: according to the change [symbol] q of vehicles' queue q or an instruction, vehicles in a phase take permit time tqp successively from other predicated-minor phases of every intersection in order to meet a long queue to pass, so-called solitary wave, where the other predicated-minor phases means that during the phase time there is less vehicle to pass or an instruction, predicated-minor phases are not main traffic flow, may be from empirical predication;

S4 run RATIO mode after running out the interim-period;

S5 determine whether to start time-differential control according to a mode-instruction or the information from equipped sensors for vehicle queue's head: analyze the vehicle's queue's head information q0 from every phase vehicles' queue-head sensors, determine whether to switch differential control (differential/quantum phase change state): when vehicle at q0 is within safe distance, allot one differential time (i.e., quantum phase-change time) [symbol] t to the q0 in a phase from other phases with no vehicle and an opening green light of RATIO mode, and set a differential state;

S6 determine whether to be differential (quantum phase-change) state: if yes, then returns S5, else run S3;

Another feature of the present invention is that step S2 includes steps of:

S21 said tail q means the last vehicle's position and its distance from its heading intersection, standing for the vehicles' queue's length, said head q0 means the most front vehicle's position and its distance from its heading intersection, said tail q may be obtained from real time traffic meter-precision positioning data, such as a vehicle positioning device or a mobile phone positioning plug-in, or a common traffic sensing device, such as video, microwave radar, etc., that can measure the last car of a car in real time, said head information can be obtained by using a high real-time traffic video analysis device or microwave, large data, and any other device that can detect the first car in real time;

Another feature of the present invention is that step S2 includes steps of:

S22 said road-queue time-offset trq is a basic time-offset of pan-greenwave, responses to said tail q, for obtaining no redundance the following formula\textcircled{3} must be met, so-called pan-greenwave no-redundance-law: signal time-offset trq between two adjacent intersections equals to the difference of set-drive-time tv \textcircled{4} and queue-interfering time tqx of the road-segment, said difference >0, =0, <0 indicates that there exits three inter-linked time-intervals response to the queue change and its way for no-redundant-stop: the way of difference >0 is state Lead for no-redundant stop, the way of difference=0 is state Balance for no-redundant stop, the way of difference <0 is state Relief for no-redundant stop: that's, road-queue time-offset trq=set-drive-time tv−queue-interfering-time tqx, trq=d/v0−(1/v0+a)*q, where d is distance-meter between adjacent intersections, v0 is set-greenwave-speed-meter/sec under set-drive-speed of a road-segment, q is the length of vehicles' queue in its flow direction of a road-segment, a is said VQ-start-coefficient is valued in 0.14 to 0.22, taking the median 0.18 of them, unit: second/meter, or given a value dynamically with a control system analysis, a*q=tq\textcircled{5} is start-time of a vehicles' queue q;

Another feature of the present invention is that step S2 includes steps of:

S23 said phase-change quantum time [symbol] t is the least safe response time of time-differential ratio, said minimum safe permit response time is suggested less than or equals to 6 sec that is obtained at city speed 60 km/h, its corresponding queue head q0 ranges 40 meter-60 meter, or obtained from the direct computation on set-drive-speed of controlled road-segments;

Another feature of the present invention is that step S2 includes steps of:

S24 said real time traffic information further includes walkers information wr0 at two sides of crosswalk area and wrx in crosswalk area in every direction, obtained with any sensing device that can detect these pedestrian information in real time by using video analysis, infrared ultrasonic microwave and so on;

Another feature of the present invention is that step S3 includes steps of:

S31 said greenwave-initiate/vanish-drift: determine the initiate, drift, vanish and their time-offsets of a greenwave's direction and channel's two ends: start-point, front-point, 1.1) according to an empirical-data' instruction, or, 1.2) self-adaption according to real time traffic flow characteristics, 1.2.1) greenwave-initiate: (1) choose the channels of potential 2-way coordinates or more road-segments with waiting vehicle queue or longer queue as greenwave channel and flow direction, configure/reconfigure/vanish a greenwave, (2) its start-point is the first intersection along a channel direction, i.e., the most upstream intersection of non-differential state or non small load (i.e., the time-distance between moving vehicles is bigger than the quantum phase-change time), its front-point is the last intersection along a channel direction, i.e., the most downstream intersection of non-differential state or non small load, (3) calculate time-offset tgw and configure its interim-period ptmp of every intersection of a greenwave channel, the time-offset is the sum of the time difference trq from the start-intersection to its downstream intersection, where the time-difference trq is that the time-distance from a moving vehicle to an intersection minus the queue-start-time tq in front of the intersection, 1.2.2) greenwave-drift: calculate and configure wave-wave interim-period from new start point and front point and their caused new intersection period-remainder and their new time-offsets that equals to the new start/front points' caused time-offsets plus its current time-offset's complement, 1.2.3) greenwave-vanish: calculate and configure wave-vanish interim-period that is new start point and front point's superposition, i.e., the number of road-segments included within the new channel 0—wave vanish;

Another feature of the present invention is that step S3 includes steps of:

S32 said greenwave-fluctuation: adjust the time-offset of every intersection according to the change [symbol] q of vehicles' queue' q or an instruction after wave-initiate: take the time trq's change [symbol] trq caused by the change [symbol] q into the time-offset tgw, trq of the local intersection and its downstream intersections, which is inverse ratio change, increased queue leads [symbol] trq<0 and trq decrement, decreased queue leads [symbol] trq>0 and trq increment, concrete to calculate: [symbol] trq= [symbol] tqx=tqx2−tqx1=−(1/v0+a)* [symbol] q, [symbol] q=q2−q1, q1—queue length at previous instant, q2—queue length at current instant;

Another feature of the present invention is that step S3 includes steps of:

S33 said greenwave state-change: change state among Lead, Balance, Relief according to the change [symbol] q of vehicles' queue q or an instruction after wave-initial: obtain road-queue time-offset trq=tv−tqx,

When trq[j]<0 of the intersection occurs under the state of trq[i]>0 of an intersection, configure the intersection as Relief start point and its current upstream intersection the state of Relief, and keep the current states of other intersections in the greenwave channel unchanged, by one of ways: (1) take the time-offsets tgw[i] of the q flow-to-intersection in Lead state out from the intersection's tgw[i] and its downstream intersections' tgw[i−d], (2) add the difference of absolute value |trq[j]|−trq[j+1] to its upstream intersections' tgw[i+u], (3) or make the new time-offsets an interim-period,

When trq[j]>0 of an intersection occurs under the state of trq[i]<0 of the intersection, configure the intersection as Lead state and its previous downstream intersection as the Lead start point, and keep the current states of other intersections in the greenwave channel unchanged, by one of ways: (1) take the time-offsets tgw[i] of the q from-intersection in Relief state out from the intersection's tgw[i] and its upstream intersections' tgw[i+u], (2) add the trq[j] to its downstream intersections' tgw[i−d], (3) or make the new time-offsets an interim-period,

When trq[j]=0 of an intersection, using 0 time-offset configure the q flow-to-intersection's time-offset into Balance state and make corresponding time-offset-adjust for other intersection.

Another feature of the present invention is that step S3 includes steps of:

S34 said solitary wave: according to the change [symbol] q of vehicles' queue's q or an instruction, vehicles in a phase take permit time tqp successively from other predicated-minor phases of every intersection in order to meet a long queue to pass, so-called solitary wave, where the other predicated-minor phases means that during the phase time there is less vehicle to pass or an instruction, predicated-minor phases are not main traffic flow, may be from empirical predication;

Another feature of the present invention is that step S34 includes steps of:

S341 said solitary-wave's long queue's taking permit time tqp should meets the following relation: tqp=p*q/w, where w is the length equivalent to one standard car including distance between two cars in a vehicles' queue, usually is 5 meters-7 meters, takes the median 6 meters/car, p is the average time interval of two cars in a queue when they pass successively by traffic signals of an intersection, that's, average car's heads' time-interval, usually is 2.2 seconds-1.8 seconds, takes the median 2 seconds/car;

Another feature of the present invention is that step S5 includes steps of:

S51 said “allot one differential time (i.e., quantum phase-change time) [symbol] t to the q0 in a phase from other phases with no vehicle and an opening green light of RATIO mode”, when there are multiple “other phases”, take the [symbol] t in preset direction, phase, in time order;

Another feature of the present invention is that step S5 includes steps of:

S52 said “allot one differential time (i.e., quantum phase-change time) [symbol] t to the q0 in a phase from other phases with no vehicle and an opening green light of RATIO mode”, when there are multiple “other phases”, the phases in the same controlling direction are preference to the ones in different directions, and the phase in opening green light is preference to others in the same direction;

Another feature of the present invention is that step S5 includes steps of:

S53 said “according to a mode-instruction or the information from equipped sensors for vehicle queue's head”, including walkers sensors, to determine whether to start differential control: analyze the vehicle queue's head information q0 from every phase vehicle' queue-head sensors and walkers' sensors, determine whether to switch differential control (differential/quantum phase change state): when vehicle at q0 is within safe distance, allot the q0 in a phase one differential time (i.e., quantum phase-change time) [symbol] t from other phases with neither vehicle nor walker and an opening green light of RATIO mode, and set a differential state;

The advantages of the present invention are below: 1) optimal organically unifying the control methods of broad spectrum differential greenwave for light load, Lead greenwaves for median-large load, Balance and Relief greenwaves for near-satured and satured load, switches among and connects them smoothly in the way of lower energy consumption, avoids redundant stops/starts 1 time equivalent to 30 seconds idle fuel consumption per vehicle per signal period per road-segment, usually stops/starts 30 vehicles's time equivalent to 15 minutes idle fuel consumption per signal period per road-segment; 2) its four-state switched smoothly in a traffic channel provides a serial continuity solution means for signal control to Dissolve the congestion core, early congestion, delay the arrival of a large cluster of congestion; 3) its solitary wave subtly sends the bursts of sudden heavy traffic to their own dissipation, more early eliminates this type of load as a potential cause of the “nuclear expansion” latent danger.

Note: \textcircled{1} Said time-offset greenwave is Adjust/time-offset Ratio mode, including Synchronization/Balance mode of “0” time-offset Ratio, Lead mode of the same direction of traffic and greenwave, Relief mode of the reverse direction of traffic and greenwave, 3 corresponding direction time-offset “0/+/−” states; \textcircled{2} said pan-greenwave control method comprises the following 6 steps including transformation: 1) when step S3 configure 0 time-offset, pan-greenwave method naturally becomes “differential greenwave” method, 2) when a mode-instruction of “do not use Differential greenwave S5” is received or no relative sensors and data collectors are equipped for step S5, pan-greenwave method naturally does not contain function “Differential greenwave” rather stay in state non-Differential state; \textcircled{3} said relation formula: road-queue time-offset formula trq=tv−tqx=d/v0−(1/v0+a)*q disclose the relation of signal-time-offset and greenwave-speed, queue-length, redundant-time, and their response and change law including non-redundant needed anti-traffic-direction greenwave's existence and its conditions, direct impact on traffic signal system redundancy, is concepts and tools necessary for non redundant system design, is a basic relation formula of traffic signal efficiency and redundancy control, or pan-greenwave—no redundant basic laws of time-offsets; \textcircled{4} said set-drive-time d/v0's further feature that decreases brake-time at set-greenwave-drive-speed v0; \textcircled{5} said vehicle-queue-start-time tq's further feature that equals VQ-start-coefficient a*jam-coefficient j*queue-length d*apart-coefficient s, where said j am-coefficient j=q/d is less than or equals to 1, q=d, j equals to 1 jammed vehicle-queue-length qd means heavy jam, said apart-coefficient s is bigger than or equal to one, equals to one for keeping present status, said VQ-start-coefficient a is valued in 0.14 to 0.22, taking the median 0.18 of them, unit: second/meter, or given a value dynamically with a control system analysis, \textcircled{6} said jammed queue-length qd's feature that is qd minus the length of the queue's upstream intersection without vehicle occupied multiply by a value less than one; \textcircled{7} Said jammed queue-length qd's feature that is qd plus the length of the traffic upstream intersection with vehicles fully filled;

### BRIEF DESCRIPTION OF THE DRAWINGS

FIG. 1 is a flowchart of pan-greenwave control method;

FIG. 2 is a roadnet structure, road-segments' traffic-time, and at 600 sec of pan-greenwave, queues at intersections and time-offsets of greenwave-initial;

FIG. 3-a shows at 628 sec of pan-greenwave, fluctuation and queues' change at intersections of west-2 channel;

FIG. 3-b shows at 628 sec of pan-greenwave, drift and queues' change at intersections of west-2 channel;

FIG. 3-c shows at 643 sec of pan-greenwave, solitary wave and queues' change at intersections of west-2 channel;

FIG. 3-d shows at 988 sec of pan-greenwave, state-change and queues' change at intersections of west-2 channel;

### LIST OF REFERENCE NUMERAL UTILIZED IN THE DRAWING

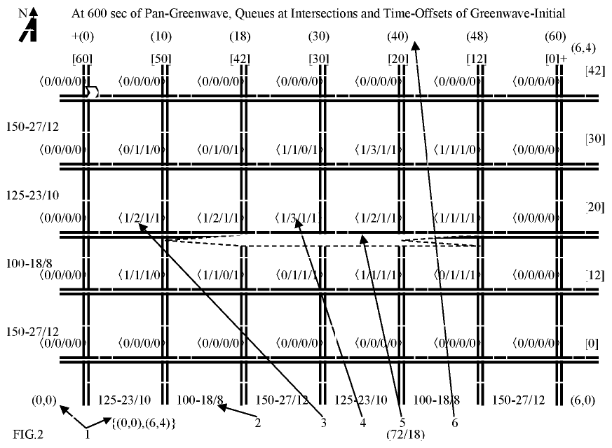

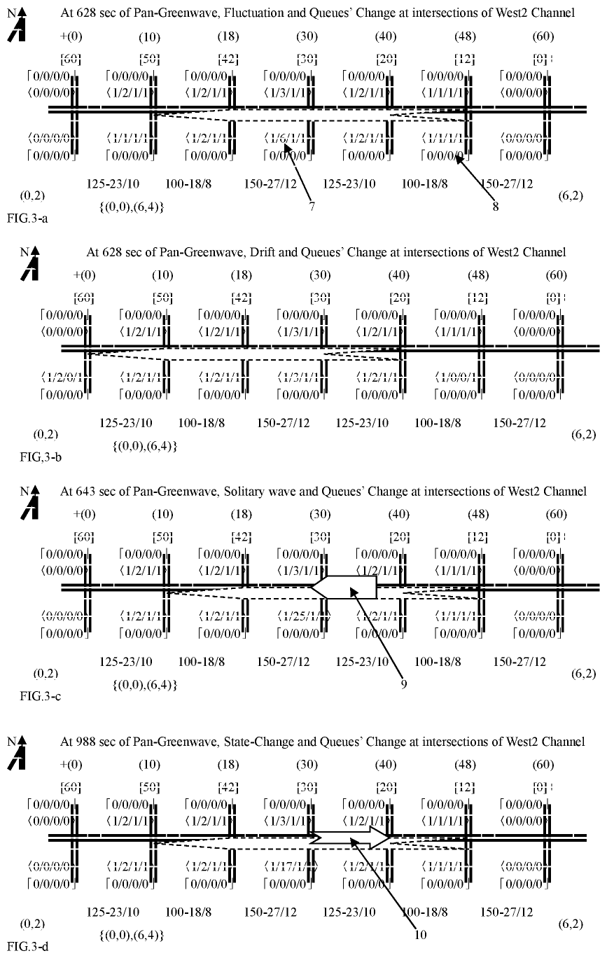

FIG. 2: 1—{(0,0),(6,4)} is roadnet mark: represent the origin of roadnet and intersection coordinates with (0,0) at lower-left corner, which spans from the origin to the right, plus 6 columns, to the up, plus 4 rows; 2—“#-#/#” is for three values: distance between two adjacent intersections—JVQ-start-time/set-drive-time, unit: meter—seconds/seconds, such as row-road-segment (0,1)'s distance d=100 meters, JVQ-start-time tqd=18 sec, set-drive-time tv=8 sec at speed 45 km/h; 3—row-channel 2 {*}, the “*” is for some value or values of the channel's road-segments or intersections, such as said “distance between two adjacent intersections—JVQ-start-time/set-drive-time denoted by #-#/#”; 4—the cusp brackets [symbol] 1/3/1/1 [symbol] indicates its right-lower intersection with 4 tqx=(1/v0+a)*q corresponding to the 4 queues' length q in East/West/South/North 4 car directions, here the 4 tqx values of the intersection (3,2) are 1,3,1,1; 5—dotted hollow arrow is for a Lead greenwave and its direction starting, its length covers the road-segments running the greenwave, from intersection (5,2) to intersection (1,2), the head of the arrow is the front intersection (1,2) of the greenwave flow direction, the tail of the arrow is the start-intersection (5,2) of the greenwave; 6—the number 20 in square brackets is time-offset of greenwave and direction West from its most right intersection as a start-point, belongs to its underneath intersections, the number 40 in brace brackets is time-offset of greenwave and direction East from its most left intersection as a start-point, the number at the right side of the Figure are based on the same principles, and the same meaning for all FIG. 3s;

FIG. 3-a: 7—the cusp brackets and its number at the lower-left of an intersection means that at 628 sec queues at intersections, for an example, intersection (3,2)'s lower-left cusp brackets [symbol] 1/6/1/1 [symbol] compare with the previous [symbol] 1/3/1/1 [symbol] at upper-left of the intersection, increase 3 sec queue, equivalent to 11.5 meters or 2 cars, becomes 6 sec queue 23 meters 4 cars; 8—the corresponding right angle brackets ┌0/0/0/0┘ of an intersection compare with its previous left-phase queues, such as intersection (3,2)'s lower-left ┌0/0/0/0┘, no change and all are 0 sec;

FIG. 3-c: 9—long queue is becoming a solitary wave;

FIG. 3-d: 10—the road-queue time-offset trq<0 of intersection (3,2) causes greenwave from Lead mode switch to reverse-direction Jam-Relief mode;

### DETAILED DESCRIPTION OF THE INVENTION

### Description of the Preferred Embodiments, Industry Applications

A detailed description of an embodiment of the invention in conjunction with the accompanying drawings:

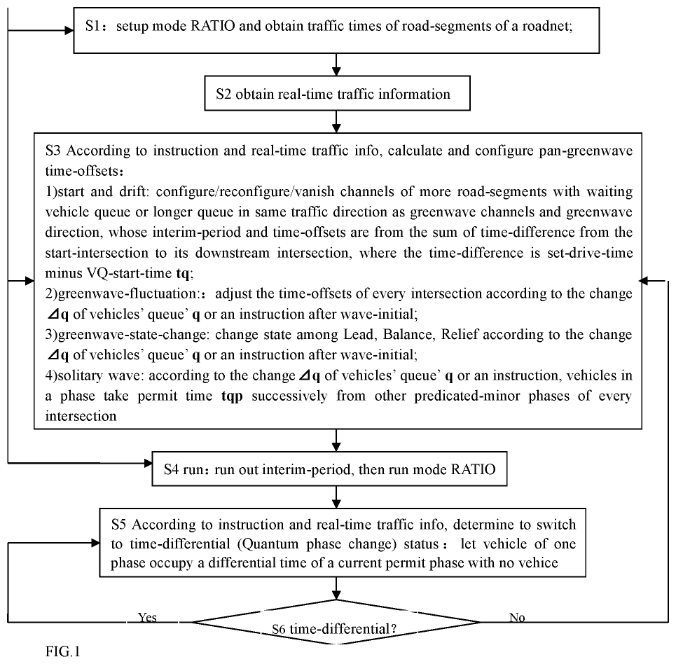

According to traffic signal pan-greenwave control method flow as shown in FIG. 1, implement a traffic control system software controlling roadnet as shown in FIG. 2, where the roadnet is marked as {(0,0), (6,4)} or {7,5}, representing 5 rows 7 columns coordinates, the set of the parameters of the col-D-channels denoted as Col.{7,5−1} {==} for 7 columns each having 5−1 road-segments, the m-th Col.-channel denoted as Col.m{==}, ==for 4 road-segments's parameters, the set of the parameters of the row-D-channels denoted as Row.{5,7−1} {==} for 5 rows each having 7-1 road-segments, the n-th Row-channel denoted as Row.n{==}, ==for 6 road-segments's parameters; total road-segments is about 5*(7−1)+7*(5−1), it is not a must for absolute parallelism of road-segments, the elements of the set are each road-segment's length d [symbol] its JVQ-start-time tqd, its set-drive-time tv; intersections are equipped with straight-left 2 phases signals or their controller or traffic sensors [symbol] video analyzors [symbol] microwave [symbol] infra-red detectors [symbol] or vehicle-positioning equipment that can obtain positioning data from a vehicle, which get mode-instructions from center control system through internet; run steps as follow: S1 setup RATIO signal mode and obtain the traffic-time of said road-segment: (1) set North as signal main direction for all intersections in the roadnet, cycle period=60 seconds, the time ratio for directions=1, each direction 45 seconds, straight/left 2-phase ratio=2, straight phase 30 seconds, left phase 15 seconds; (2) and get a rectangle from the roadnet, including 7×5 intersections with 7 col.-channels and 5 row-channels, and their road-segments' set-drive-speed v0=45 km/h=12.5 m/sec [symbol] their JVQ-start-coefficient a=0.18 sec/m, where the apart-coefficient set 1 for keeping the unprocessed, and omitting the length of the intersection;

S2: obtain real-time traffic information: queue-tail q from vehicle-positioning system 1 time/sec, queue-head q0 from video-analyzer 1 time/sec, calculate trq, [symbol] trq:

1) Trq=(d−q)/v0−a*q=tv−tqx=0.08*d−0.26*q,

2) [symbol] trq=− [symbol] tqx=−(1/v0+a)* [symbol] q=−0.26* [symbol] q=−0.26*(q2−q1), where q1 [symbol] q2 are two queue-tails obtained at two instant, q2 is earlier than q1 in time, correspondingly, tqx2 [symbol] tqx1;

S3: this embodiment uses self-adaption rather than empirical instruction, in the beginning 600 seconds, traffic flow is less and its time-distance bigger than 6 seconds, broad-band differential greenwave runs, no greenwave time-offsets and their interim-periods are generated;
S4: the interim-period=0, run RATIO mode;
S5: the heads of queues from the sensors at intersections starts the time-differential operations: analyze the position q0 of queue's head [symbol] determine when to switch to time-differential state and run differential greenwave: the permit phase is considered no-vehicle when q0>40 meters and one differential time of its permit may be sent to a non-permit phase with vehicles; at the 1000^{th} second the intersections are still in time-differential state, as follows:
Channel-row 0 { [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] };
Channel-row 4 { [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] };
Channel-col. 0 { [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] };
Channel-col. 6 { [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] , [symbol] 0/0/0/0 [symbol] };
The rest of intersections run normal RATIO mode because their traffic increment forms sufficient long queues;
These non-time-differential state intersections run step S6 to determine,
Return to step S3;

As shown in FIG. 2, S3 embodiment of acts of greenwave-initiate:

S3 greenwave-initiate self-adaption from 1.2.1): (1) choose channel west2 to generate west Lead greenwave and configure the greenwave-initiate interim-period because channel west2 contains more road-segments with queue, their queues longer and their not suitable for 2-way coordinates, (2) the start-point is intersection (5,2), the front is intersection (1,2), (3) intersections' trq as follows: Channel West2 trq{−,8−2,12−2,10−3,8−2,0,−}={−,6,10,7,6,0,−}, where “−” means that the intersection is not in a greenwave channel, #−# is that set-drive-time tv minus tqx, both are from trq formula, for an example, 12−2 are from 150-meter road-segment's set-drive-time 12 sec minus queue-loss-time 2 sec obtains 10 sec time-offset;
According to time-offset formula tgw of Lead greenwave, obtain the sum of road-segment's trq from start-intersection to one of its downstream intersections in the channel, the calculations of the intersections as follows:
Before greenwave-initiate, Channel West2 tgw {−,0,0,0,0,0,−},
After greenwave-initiate, Channel West2 tgw {−,29,23,13,6,0,−},
Or their interim-periods Channel West2 ptmp {−,15+14,12+11,+13,+6,0,−}, where “+#” is inserted into the rest time of the period at that time;
Then run S4->S5->S6 to recycle.
The following are the embodiments of the configurations and acts for fluctuation [symbol] drift [symbol] solitary wave [symbol] state-change after greenwave-initiate;

As shown in FIG. 3-a, the 2) acts for fluctuation of S3:

The queue's change of intersection (3,2) is <1/6/1/1>, i.e., west-straight-phase queue is 6 second, 3 sec more than previous 3 sec, formula [symbol] trq= [symbol] tqx=−0.26* [symbol] q=−0.26*(q2−q1)=−3 second,
Before fluctuation, channel west2 time-offset tgw {−,29,23,13,6,0,−},
Intersection (3,2) and its downstream intersections respectively decrease 3 seconds from their own time-offset tgw, that's,
After fluctuation, channel west2 time-offset tgw {−,29−3,23−3,13−3,6,0,−}={−,26,20,10,6,0,−}, or get their interim-period, west2 ptmp{−,−3,−3,−3,0,0,−}.

As shown in FIG. 3-b, the 1.2.2) acts for drift of S3:

Before, channel west2 queue-loss-time tqx {0,2,2,3,2,1,0}, time-offset tgw {−,29,23,13,6,0,−},
Before drift, channel west2 queue-loss-time tqx{2,2,2,3,2,0,0}, time-offset tgw {−, 29,23,13,6,0,−},
New start-point, new front point: intersection (0,2), (5,2),
West queue change of two end points of the greenwave channel cause drift acts:
channel west2 time-offset tgw {10−2+29−6, 29−6, 23−6, 13−6, 6−6, −, −}={31,23,17,7,0,−,−},
or channel west2 interim-period {+31,−6,−6,−6,−6,−,−}={16+15,−6,−6,−6,−6,−,−}, where “−#” means that the rest time of the current period directly decreases the number #.

As shown in FIG. 3-c, the 4) acts for solitary wave of S3:

Before, channel west2 tqx1 {0,2,2,3,2,1,0}, time-offset tgw {−, 29,23,13,6,0,−},
After, channel west2 tqx2 {0,2,2,25,2,1,0}, queue-loss-time,
the west queue increment of intersection (3,2) of the greenwave channel causes solitary wave acts:
the west greenwave signals of Intersection (3,2) and its downstream intersections ought to occupy other phases' time to let the 25 sec queue pass by,
The long queue need time tqp to pass the intersection: tqp=p*q/w=2q/6=q/3=96/3=32 secs, where queue q=west2 tqx2(3)/a=25/0.26=96 meter, 12 sec more than the 20 seconds of the straight-phase, intersection (3,2) west straight phase needs to use 12 seconds of other phases;
its downstream intersections execute same decision and acts.

As shown in FIG. 3-d, the 3) acts for state-change of S3: Lead->Relief,

The intersections with [symbol] q>0 are intersection (3,2), intersection (2,2);
Use formula trq, trq[j]=0.08*d−tqx[j]:
Before, west2 queue-loss-time tqx1 {0,2,2,3,2,1,0},
west2 trq[j]=0.08*d−tqx[j]={−,8,12,10,6,11,−}−{0,2,2,3,2,1,0},
west2 trq {−,6,10,7,6,0,−}, all trq>0, in Lead state,
west2 time-offset tgw {−,29,23,13,6,0,−}, intersection (5,2) is start point, time-offset tgw=0; after, trq(3)=0.08*d−tqx=10−17=−7<0, switch to Relief state:

west2 queue-loss-time tqx2 {0,2,10,17,2,1,0},

west2 trq {−,6,2,−7,6,0,−}, trq(3)=−7 is negative road-queue-time-offset, intersection (3,2)'s upstream intersection should be configured as Relief, decrease the [symbol] trq of every intersection from the intersection itself s tgw and its downstream intersection, from the most downstream intersection;

trq(1)=6, [symbol] trq=0, west2 time-offset tgw {−, 29−0, 23, 13, 6, 0, −},

trq(2)=2, [symbol] trq=−8, west2 time-offset tgw {−, 29−8, 23−8, 13, 6, 0, −},

trq(3)=−7<0, [symbol] trq=−13, west2 time-offset tgw {−, 21−13, 15−13, 13−13, 6, 0, −},

and add the absolute value |trq[3]|−trq[4] to tgw(i) (i>=4) of the upstream intersections,

get the difference of absolute value |trq(3)| and its upstream intersection's trq:|trq(3)|−trq(4)=7−6=1,

west2 time-offset tgw {−,8,2,0,6+1,0+1,−}={−,8,2,0,7,1,−},

or west2 interim-period {−,−8−13,−8−13,−13,+1,+1,−}={−,−21,−21,−13,+1,+1,−}.

What is claimed as new and desired to be protected by Letters Patent is set forth in the following:

1. A method for traffic pan-greenwave mode in road traffic signal network includes steps\textcircled{2}:
S1: Initialize signal system as mode RATIO with obtaining the length d and traffic-time of road-segments of a roadnet: set-drive-time tv, tv=d/v0, v0—set-drive-speed following a green wave in set direction of a road-segment;
S2 obtain real time traffic information: the tail q of vehicles' queue in every road-segment, the head q0 info of this queue, road-queue time-offset trq, phase-change quantum time [symbol] t (i.e., differential time);
S3 calculate and configure pan-greenwave time-offset tgw according to a mode-instruction or vehicles' queue's length at an intersection: 1) greenwave-initiate/vanish-drift: determine the initiate, drift, vanish and their time-offsets of a greenwave's direction and channel's two ends: start-point, front-point, 1.1) according to an empirical-data' instruction, or, 1.2) self-adaption according to real time traffic flow characteristics, 1.2.1) greenwave-initiate: (1) choose the channels of potential 2-way coordinates or more road-segments with waiting vehicle queue or longer queue as greenwave channel and flow direction, configure/reconfigure/vanish a greenwave, (2) its start-point is the first intersection along a channel direction, i.e., the most upstream intersection of non-differential state or non small load (i.e., the time-distance between moving vehicles is bigger than the quantum phase-change time), its front-point is the last intersection along a channel direction, i.e., the most downstream intersection of non-differential state or non small load, (3) calculate time-offset tgw and configure its interim-period of every intersection of a greenwave channel, the time-offset is the sum of the time difference from the start-intersection to its downstream intersection, where the time-difference is that the time-distance from a moving vehicle to an intersection minus the queue-start-time tq in front of the intersection, 1.2.2) greenwave-drift: calculate and configure wave-wave interim-period from new start point and front point and their caused new intersection period-remainder and their new time-offsets that equals to the new start/front points' caused time-offsets plus its current time-offset's complement, 1.2.3) greenwave-vanish: calculate and configure wave-vanish interim-period that is new start point and front point's superposition, i.e., the number of road-segments included within the new channel 0—wave vanish, 2) greenwave-fluctuation: adjust the time-offset of every intersection according to the change [symbol] q of vehicles' queue q or an instruction after wave-initiate: take the time trq's change [symbol] trq caused by the change [symbol] q into the time-offsets tgw, trq of the local intersection and its downstream intersections, which is inverse ratio change, increased queue leads [symbol] trq<0 and trq decrement, decreased queue leads [symbol] trq>0 and trq increment; 3) greenwave state-change: change state among Lead, Balance, Relief according to the change [symbol] q of vehicles' queue q or an instruction after wave-initiate: with queue's increment, the time-offset trq in Lead state decreases to 0 and becomes Balance state, with queue's increment further, the trq<0 and switches to Relief state, and conversely, with decrement q, the time-offset trq<0 in Relief state increases to 0 and becomes Balance state, with further decrement q, the trq>0 and switches to Lead state; 4) solitary wave: according to the change [symbol] q of vehicles' queue q or an instruction, vehicles in a phase take permit time tqp successively from other predicated-minor phases of every intersection in order to meet a long queue to pass, so-called solitary wave, where the other predicated-minor phases means that during the phase time there is less vehicle to pass or an instruction, predicated-minor phases are not main traffic flow, may be from empirical predication;
S4 run RATIO mode after running out the interim-period;
S5 determine whether to start time-differential control according to a mode-instruction or the information from equipped sensors for vehicle queue's head: analyze the vehicle's queue's head information q0 from every phase vehicles' queue-head sensors, determine whether to switch differential control (differential/quantum phase change state): when vehicle at q0 is within safe distance, allot one differential time (i.e., quantum phase-change time) [symbol] t to the q0 in a phase from other phases with no vehicle and an opening green light of RATIO mode, and set a differential state;
S6 determine whether to be differential (quantum phase-change) state: if yes, then returns S5, else run S3.

2. A method as defined in claim 1, wherein step S2 includes the steps of:
S21 said tail q means the last vehicle's position and its distance from its heading intersection, standing for the vehicles' queue's length, said head q0 means the most front vehicle's position and its distance from its heading intersection, said tail q may be obtained from real time traffic meter-precision positioning data, such as a vehicle positioning device or a mobile phone positioning plug-in, or a common traffic sensing device, such as video, microwave radar, etc., that can measure the last car of a car in real time, said head information can be obtained by using a high real-time traffic video analysis device or microwave, large data, and any other device that can detect the first car in real time.

3. A method as defined in claim 1, wherein step S2 includes the steps of:
S22 said road-queue time-offset trq is a basic time-offset of pan-greenwave, responses to said tail q, for obtaining no redundance the following formula\textcircled{3} must be met, so-called pan-greenwave no-redundance-law: signal time-offset trq between two adjacent intersections equals to the difference of set-drive-time tv\textcircled{4} and queue-interfering time tqx of the road-segment, said difference >0, =0, <0 indicates that there exits three inter-linked time-intervals response to the queue change and its way for no-redundant-stop: the way of difference >0 is state Lead for no-redundant stop, the way of difference=0 is state Balance for no-redundant stop, the way of difference <0 is state Relief for no-redundant stop: that's, road-queue time-offset trq=set-drive-time tv—queue-interfering-time tqx, trq=d/v0−(1/v0+a)*q, where d is distance-meter between adjacent intersections, v0 is set-greenwave-speed-meter/sec under set-drive-speed of a road-segment, q is the length of vehicles' queue in its flow direction of a road-segment, a is said VQ-start-coefficient is valued in 0.14 to 0.22, taking the median 0.18 of them, unit: second/meter, or given a value dynamically with a control system analysis, a*q=tq\textcircled{5} is start-time of a vehicles' queue q.

4. A method as defined in claim 1, wherein step S2 includes the steps of:
S23 said phase-change quantum time [symbol] t is the least safe response time of time-differential ratio, said minimum safe permit response time is suggested less than or equals to 6 sec that is obtained at city speed 60 km/h, its corresponding queue head q0 ranges 40 meter-60 meter, or obtained from the direct computation on set-drive-speed of controlled road-segments.

5. A method as defined in claim 1, wherein step S2 includes the steps of:
S24 said real time traffic information further includes walkers information wr0 at two sides of crosswalk area and wrx in crosswalk area in every direction, obtained with any sensing device that can detect these pedestrian information in real time by using video analysis, infrared ultrasonic microwave and so on.

6. A method as defined in claim 1, wherein step S3 includes the steps of:
S31 said greenwave-initiate/vanish-drift: determine the initiate, drift, vanish and their time-offsets of a greenwave's direction and channel's two ends: start-point, front-point, 1.1) according to an empirical-data' instruction, or, 1.2) self-adaption according to real time traffic flow characteristics, 1.2.1) greenwave-initiate: (1) choose the channels of potential 2-way coordinates or more road-segments with waiting vehicle queue or longer queue as greenwave channel and flow direction, configure/reconfigure/vanish a greenwave, (2) its start-point is the first intersection along a channel direction, i.e., the most upstream intersection of non-differential state or non small load (i.e., the time-distance between moving vehicles is bigger than the quantum phase-change time), its front-point is the last intersection along a channel direction, i.e., the most downstream intersection of non-differential state or non small load, (3) calculate time-offset tgw and configure its interim-period ptmp of every intersection of a greenwave channel, the time-offset is the sum of the time difference trq from the start-intersection to its downstream intersection, where the time-difference trq is that the time-distance from a moving vehicle to an intersection minus the queue-start-time tq in front of the intersection, 1.2.2) greenwave-drift: calculate and configure wave-wave interim-period from new start point and front point and their caused new intersection period-remainder and their new time-offsets that equals to the new start/front points' caused time-offsets plus its current time-offset's complement, 1.2.3) greenwave-vanish: calculate and configure wave-vanish interim-period that is new start point and front point's superposition, i.e., the number of road-segments included within the new channel 0—wave vanish.

7. A method as defined in claim 1, wherein step S3 includes the steps of:
S32 said greenwave-fluctuation: adjust the time-offset of every intersection according to the change [symbol] q of vehicles' queue' q or an instruction after wave-initiate: take the time trq's change [symbol] trq caused by the change [symbol] q into the time-offset tgw, trq of the local intersection and its downstream intersections, which is inverse ratio change, increased queue leads [symbol] trq<0 and trq decrement, decreased queue leads [symbol] trq>0 and trq increment, concrete to calculate: [symbol] trq= [symbol] tqx=tqx2−tqx1=−(1/v0+a)* [symbol] q, [symbol] q=q2−q1, q1—queue length at previous instant, q2—queue length at current instant.

8. A method as defined in claim 1, wherein step S3 includes the steps of:
S33 Said greenwave state-change: the state of the traffic signals at an intersection is to be changed among the three states of Lead, Balance, and Relief according to vehicle-queues; when in Relief state, trq[j]<0 of the intersection occurs under the state of trq[i]>0 of an intersection, configure the intersection as Relief start point and its current upstream intersection the state of Relief, and keep the current states of other intersections in the greenwave channel unchanged: (1) take the time-offsets tgw[i] of the q flow-to-intersection in Lead state out from the intersection's tgw[i] and its downstream intersections' tgw[i−d], (2) add the difference of absolute value |trq[j]|−trq[j+1] to its upstream intersections' tgw[i+u], (3) or make the new time-offsets an interim-period;
When in Lead state, trq[j]>0 of an intersection occurs under the state of trq[i]<0 of the intersection, configure the intersection as Lead state and its previous downstream intersection as the Lead start point, and keep the current states of other intersections in the greenwave channel unchanged: (1) take the time-offsets tgw[i] of the q from-intersection in Relief state out from the intersection's tgw[i] and its upstream intersections' tgw[i+u], (2) add the trq[j] to its downstream intersections' tgw[i−d], (3) or make the new time-offsets an interim-period;
When trq[j]=0 of an intersection occurs, configure the intersection as Balance state.

9. A method as defined in claim 1, wherein step S3 includes the steps of:
S34 said solitary wave: according to the change [symbol] q of vehicles' queue's q or an instruction, vehicles in a phase take permit time tqp successively from other predicated-minor phases of every intersection in order to meet a long queue to pass, so-called solitary wave, where the other predicated-minor phases means that during the phase time there is less vehicle to pass or an instruction, predicated-minor phases are not main traffic flow, may be from empirical predication.

10. A method as defined in claim 12, wherein step S34 includes the steps of:
S341 said solitary-wave's long queue's taking permit time tqp should meets the following relation: tqp=p*q/w, where w is the length equivalent to one standard car including distance between two cars in a vehicles' queue, usually is 5 meters-7 meters, takes the median 6 meters/car, p is the average time interval of two cars in a queue when they pass successively by traffic signals of an intersection, that's, average car's heads' time-interval, usually is 2.2 seconds-1.8 seconds, takes the median 2 seconds/car.

11. A method as defined in claim 1, wherein step S5 includes the steps of:
S51 said “allot one differential time (i.e., quantum phase-change time) [symbol] t to the q0 in a phase from other phases with no vehicle and an opening green light of RATIO mode”, when there are multiple “other phases”, take the [symbol] t in preset direction, phase, in time order.

12. A method as defined in claim 1, wherein step S5 includes the steps of:
S52 said “allot one differential time (i.e., quantum phase-change time) [symbol] t to the q0 in a phase from other phases with no vehicle and an opening green light of RATIO mode”, when there are multiple “other phases”, the phases in the same controlling direction are preference to the ones in different directions, and the phase in opening green light is preference to others in the same direction.

13. A method as defined in claim 1, wherein step S5 includes the steps of:
S53 said “according to a mode-instruction or the information from equipped sensors for vehicle queue's head”, including walkers sensors, to determine whether to start differential control: analyze the vehicle queue's head information q0 from every phase vehicle' queue-head sensors and walkers' sensors, determine whether to switch differential control (differential/quantum phase change state): when vehicle at q0 is within safe distance, allot the q0 in a phase one differential time (i.e., quantum phase-change time) [symbol] t from other phases with neither vehicle nor walker and an opening green light of RATIO mode, and set a differential state.
